(19) United States
(12) Patent Application Publication
(10) Pub. No.: US 2026/0087740 A1
(43) Pub. Date: Mar. 26, 2026

(54) MERGING COPLANAR CONVEX POLYGONS IN CONSTRUCTIVE SOLID GEOMETRY (CSG)

(71) Applicant: Roblox Corporation, San Mateo, CA (US)

(72) Inventors: Mehdi RAHIMZADEH, San Mateo, CA (US); Tsvetan G. TSVETANOV, Santa Cruz, CA (US)

(73) Assignee: Roblox Corporation, San Mateo, CA (US)

(21) Appl. No.: 18/895,189

(22) Filed: Sep. 24, 2024

(51) Int. Cl. G06T 17/10

(52) U.S. Cl. CPC G06T 17/10

(57) ABSTRACT

Implementations described herein relate to methods, systems, and computer-readable media to cut between coplanar convex polygons. In some implementations, a method includes obtaining the polygons, constructing a corresponding initial coplanar graph, adding that graph into a queue, and cutting each graph in the queue, the cutting including identifying whether the graph includes at least one concave boundary vertex. If there is no concave boundary vertex, the graph is added to a set of result graphs. If there is at least one concave boundary vertex, the cutting selects a starting vertex, finds an optimal cut from the starting vertex to another boundary vertex, splits the graph into subgraphs along the optimal cut, and queues the subgraphs for cutting. The cutting repeats until a termination criterion is satisfied. The method then outputs the result graphs. Using these result graphs may reduce the use of computing resources, such as in real-time applications.

### TECHNICAL FIELD

Implementations relate generally to constructive solid geometry (CSG), and specifically to merging coplanar convex polygons in CSG.

### BACKGROUND

When rendering polygons, such as for constructive solid geometry (CSG), there may be a connected set of coplanar polygons, where each polygon is convex. The task is to find the minimum number of subsets of faces for the connected set, where merging faces of each subset constructs a bigger convex polygon. This is advantageous as a CSG engine using such subsets avoids having too many faces and performing the time-consuming process of performing Boolean operations with respect to the floating-point arithmetic exactly. However, this is a partitioning problem that is NP-complete.

The CSG engine within a Game Engine may perform Boolean operations for volumetric primitives (e.g. cube, sphere, cylinder, wedge, etc). The result of such Boolean operations has the form of a polyhedral mesh, which is a collection of planar faces. Each face is necessarily convex, and connected to it its neighboring faces such that the resulting polyhedral mesh is closed (or manifold). The performance (execution time, memory, etc.) of a CSG operation is proportional to the number of faces of its operands. Reducing the number of faces that represent a polyhedral mesh while keeping its shape unchanged improves the performance of the upcoming CSG operations. Such optimization can only happen by merging coplanar faces when the merged faces result in another convex face.

For example, assume a union operation between two cubes is performed. The result in the CSG engine is a polyhedral mesh comprised of faces. Then, an implementation may perform a “coplanar face merge” operation and reduce the number of faces representing the result mesh. Next, if an implementation performs another CSG operation, such as subtracting a sphere from the previous result, the CSG engine would perform fewer steps compared to when implementations did not merge coplanar faces. This phenomenon may occur because the performance of the CSG engine is related to the number of faces that represent a shape.

Some implementations were conceived in light of the above.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

Implementations of this application relate to performing merging coplanar convex polygons in Constructive Solid Geometry (CSG). For example, the merging uses a variety of techniques to achieve optimal or near-optimal results while running quickly and in a computationally efficient manner.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

According to one aspect, a computer-implemented method to cut between coplanar convex polygons is provided, comprising: obtaining a plurality of coplanar convex polygons, each polygon having a plurality of vertices connected by a plurality of edges; constructing an initial coplanar graph that represents the plurality of coplanar convex polygons, wherein vertices and edges of the initial coplanar graph correspond to respective vertices and edges of the plurality of coplanar convex polygons; adding the initial coplanar graph into a queue; cutting each graph in the queue, wherein the cutting of a graph comprises: identifying whether the graph includes at least one concave boundary vertex; if the graph includes no concave boundary vertex, adding the graph to a set of result graphs; and if the graph includes at least one concave boundary vertex: selecting the at least one concave boundary vertex of the graph as a starting vertex; finding an optimal cut from the starting vertex to another boundary vertex of the graph; splitting the graph along the optimal cut into two subgraphs; and adding the two subgraphs to the queue for cutting; repeating the cutting until one or more termination criteria is satisfied; and outputting the set of result graphs.

Various implementations of the computer-implemented method are described herein.

In some implementations, the method further comprises using the set of result graphs to render the plurality of coplanar convex polygons.

In some implementations, the identifying whether the graph includes at least one concave boundary vertex comprises: calculating graph boundary vertex angle for a vertex of the graph based on lengths of respective edges of coplanar convex polygons that connect the vertex of the graph to other vertices of the graph; and determining that the vertex is the concave boundary vertex when the graph boundary vertex angle is >π radians.

In some implementations, calculating the graph boundary vertex angle is based on an orientation predicate determinant, calculated with respect to exact arithmetic.

In some implementations, the finding the optimal cut comprises: identifying a plurality of sequences of corners in the graph being cut, each having an associated cost, wherein a corner is a path of two consecutive half-edges connecting three vertices; and selecting a particular sequence of the plurality of sequences that is associated with a cost that is lower than the respective cost for other sequences of the plurality of sequences.

In some implementations, the identifying the plurality of sequences of corners in the graph comprises: adding successive corners starting from a corner centered at the starting vertex to candidate sequences of corners until the particular sequence of corners that is associated with a cost that is lower than the respective cost for other sequences for the graph being cut is confirmed as the optimal cut for the graph being cut, wherein a successive corner is added to the candidate sequences of corners if the successive corner provides a path to reach a vertex in the graph for which no other candidate sequence of corners provides a path with a lower cost.

In some implementations, finding the optimal cut penalizes an additional corner that introduces a concave boundary vertex by increasing a cost of a sequence of corners that includes the additional corner.

In some implementations, finding the optimal cut rewards an additional corner that resolves a concave boundary vertex by decreasing a cost of a sequence of corners that includes the additional corner.

In some implementations, the computer-implemented method further includes generating circular tables of angles corresponding to vertices of each coplanar convex polygon when constructing the initial coplanar graph, wherein identifying the concave boundary vertex is based on looking up a respective angle associated with the vertex in the circular tables of angles.

In some implementations, if a corner comprises two collinear half-edges, the corner is associated with an angle measuring π radians, and otherwise the corner is associated with angles using an orientation predicate test with respect to exact arithmetic.

In some implementations, determining that one or more of the termination criteria are satisfied comprises one or more of: determining that the queue is empty; determining that an amount of progress between consecutive executions of the cutting result in a less than threshold amount of progress; or determining that an early termination threshold is met.

According to another aspect, a non-transitory computer-readable medium is provided. The non-transitory computer-readable medium with instructions stored thereon that, responsive to execution by a processing device, causes the processing device to perform operations comprising: obtaining a plurality of coplanar convex polygons, each polygon having a plurality of vertices connected by a plurality of edges; constructing an initial coplanar graph that represents the plurality of coplanar convex polygons, wherein vertices and edges of the initial coplanar graph correspond to respective vertices and edges of the plurality of coplanar convex polygons; adding the initial coplanar graph into a queue; cutting each graph in the queue, wherein the cutting of a graph comprises: identifying whether the graph includes at least one concave boundary vertex; if the graph includes no concave boundary vertex, adding the graph to a set of result graphs; and if the graph includes at least one concave boundary vertex: selecting the at least one concave boundary vertex of the graph as a starting vertex; finding an optimal cut from the starting vertex to another boundary vertex of the graph; splitting the graph along the optimal cut into two subgraphs; and adding the two subgraphs to the queue for cutting; repeating the cutting until one or more termination criteria is satisfied; and outputting the set of result graphs.

Various implementations of the non-transitory computer-readable medium are described herein.

In some implementations, the instructions cause the processing device to perform further operations comprising using the set of result graphs to render the plurality of coplanar convex polygons.

In some implementations, identifying whether the graph includes at least one concave boundary vertex comprises: calculating graph boundary vertex angle for a vertex of the graph based on lengths of respective edges of coplanar convex polygons that connect the vertex of the graph to other vertices of the graph; and determining that the vertex is the concave boundary vertex when the graph boundary vertex angle is >π radians.

In some implementations, the finding the optimal cut comprises: identifying a plurality of sequences of corners in the graph being cut, each having an associated cost, wherein a corner is a path of two non-boundary half-edges connecting three vertices; and selecting a particular sequence of the plurality of sequences that is associated with a cost that is lower than the respective cost for other sequences of the plurality of sequences.

In some implementations, the determining that one or more of the termination criteria are satisfied comprises one or more of: determining that the queue is empty; determining that an amount of progress between consecutive executions of the cutting result in a less than threshold amount of progress; or determining that an early termination threshold is met.

According to another aspect, a system is disclosed, comprising: a memory with instructions stored thereon; and a processing device, coupled to the memory, the processing device configured to access the memory, wherein the instructions when executed by the processing device cause the processing device to perform operations including: obtaining a plurality of coplanar convex polygons, each polygon having a plurality of vertices connected by a plurality of edges; constructing an initial coplanar graph that represents the plurality of coplanar convex polygons, wherein vertices and edges of the initial coplanar graph correspond to respective vertices and edges of the plurality of coplanar convex polygons; adding the initial coplanar graph into a queue; cutting each graph in the queue, wherein the cutting of a graph comprises: identifying whether the graph includes at least one concave boundary vertex; if the graph includes no concave boundary vertex, adding the graph to a set of result graphs; and if the graph includes at least one concave boundary vertex: selecting the at least one concave boundary vertex of the graph as a starting vertex; finding an optimal cut from the starting vertex to another boundary vertex of the graph; splitting the graph along the optimal cut into two subgraphs; and adding the two subgraphs to the queue for cutting; repeating the cutting until one or more termination criteria is satisfied; and outputting the set of result graphs.

Various implementations of the system are described herein.

In some implementations, the identifying whether the graph includes at least one concave boundary vertex comprises: calculating graph boundary vertex angle for a vertex of the graph based on lengths of respective edges of coplanar convex polygons that connect the vertex of the graph to other vertices of the graph; and determining that the vertex is the concave boundary vertex when the graph boundary vertex angle is >π radians.

In some implementations, the finding the optimal cut comprises: identifying a plurality of sequences of corners in the graph being cut, each having an associated cost, wherein a corner is a path of two non-boundary half-edges connecting three vertices; and selecting a particular sequence of the plurality of sequences that is associated with a cost that is lower than the respective cost for other sequences of the plurality of sequences.

In some implementations, the determining that one or more of the termination criteria are satisfied comprises one or more of: determining that the queue is empty; determining that an amount of progress between consecutive executions of the cutting result in a less than threshold amount of progress; or determining that an early termination threshold is met.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF DRAWINGS

FIG. 1 is a diagram of an example system architecture that includes a 3D environment platform to merge coplanar convex polygons, in accordance with some implementations.

FIG. 2A is a flowchart of a method to merge coplanar convex polygons in Constructive Solid Geometry (CSG), in accordance with some implementations.

FIG. 2B is a flowchart of a method for finding a cut for coplanar convex polygons in Constructive Solid Geometry (CSG) systems, in accordance with some implementations.

FIG. 3A is a diagram illustrating a corner in a graph, in accordance with some implementations.

FIG. 3B is a diagram illustrating a convex boundary corner in a graph, in accordance with some implementations.

FIG. 3C is a diagram illustrating convex boundary corners and concave boundary corners, in accordance with some implementations.

FIG. 3D is a diagram illustrating penalizing and rewarding corners, in accordance with some implementations.

FIG. 3E is a diagram illustrating representing a cut as a series of corners, in accordance with some implementations.

FIG. 4A is a diagram illustrating corners associated with rewards in a cutting algorithm, in accordance with some implementations.

FIG. 4B is a diagram illustrating finding a cut by eliminating corners, in accordance with some implementations.

FIG. 4C is a diagram illustrating further aspects of finding a cut, in accordance with some implementations.

FIG. 5A is a diagram illustrating examples of subgraphs generated by a cut, in accordance with some implementations.

FIG. 5B is a diagram illustrating examples of final subgraphs corresponding to an original graph, in accordance with some implementations.

FIG. 6A is a diagram illustrating examples of polygons in a graph, in accordance with some implementations.

FIG. 6B is a diagram illustrating an example of checking convexity and concavity for angles for a polygon in a graph, in accordance with some implementations.

FIG. 6C is a diagram illustrating examples of finding convexity, concavity, and collinearity of resulting angles from a cut, in accordance with some implementations.

FIG. 6D is a diagram illustrating a concave angle resulting from a cut, in accordance with some implementations.

FIG. 6E is a diagram illustrating a convex angle resulting from a cut, in accordance with some implementations.

FIG. 6F is a diagram illustrating a precomputed table obtained from a graph that stores information about angles in the graph, according to some implementations.

FIG. 7A is a flowchart of a method to detect and implement early termination conditions, in accordance with some implementations.

FIG. 7B is a diagram illustrating a tree structure and how subgraphs are processed, in accordance with some implementations.

FIG. 8 is a block diagram that illustrates an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

One or more implementations described herein relate to merging coplanar convex polygons in Constructive Solid Geometry (CSG). Such merging includes identifying an initial set of coplanar convex polygons. However, such an initial set may include boundary vertices that are concave (or non-convex vertices or reflex vertices). Such a vertex has an interior angle that is greater than π radians (180°). Accordingly, the set may be cut into subgraphs. Such vertices are principally referred to as concave vertices, throughout, but they may also be referred to as non-convex vertices or reflex vertices. The merging may be achieved by using an approach that requires fewer computational resources while still achieving optimal or near-optimal results. For example, some implementations may use an optimal cut algorithm related to Dijkstra's shortest path algorithm.

The techniques include finding connected coplanar polygons and creating a connected graph. Such a graph models the polygons to identify ways to cut the polygons. The vertices and edges of the graph are the vertices and edges of the mesh. Thus, each polygon is a simple loop in the graph. Such a technique identifies a concave boundary vertex. Corners are progressively added to a frontier, culling corners that do not result in an improved cut. Corners are paths of half-edges of length=2.

The corners are added until an optimal or near-optimal cut is identified. For example, a corner that introduces a concave boundary vertex is penalized, while a corner that resolves a concave boundary vertex is rewarded. Corners that form a cut that resolves as many concave boundary vertices as possible while minimizing introducing any concave boundary vertices are selected.

It is advantageous to merge coplanar convex polygons because this reduces the computing resources for rendering the polygons, which is suitable for real-time graphics applications. First, it is beneficial to the CSG engine itself. When performing consecutive CSG operations (e.g. a game in a virtual environment in which a player is creating a sculpture out of a big cube by performing consecutive CSG operations (unions and subtractions)). The resulting mesh after each CSG operation includes many coplanar convex faces. Merging these faces reduces the total number of faces that represent the resulting mesh. Therefore, the next operation would be faster and the CSG engine takes less amount of memory on the game server.

As mentioned earlier, this approach is also advantageous to rendering and networking as the resulting mesh may include a fewer number of triangles. Assume that merging two adjacent 1×1 squares results in a 2×1 rectangle. Once each convex (here, squares and rectangles) face is triangulated, the two squares result in 4 triangles while the rectangle result only in 2 triangles. Reducing the number of triangles reduces the space (memory) for keeping the triangulated mesh in server, client, or content distribution network (CDN). The communication between all these is also faster due to a lighter payload. Finally, the rendering is more efficient and faster as the triangles need to be copied to the GPU memory first and that is limited. Such limitation is different from device to device as high-end laptops have more graphics memory, while low end phones have less.

An insight regarding the technical solution described herein is that the resulting composite convex polygons generated by the techniques do not have any concave boundary angles. Therefore, implementations start cutting the graph from the edges that are connected to the concave boundary vertices. Such vertices are referred to herein as “reflex vertices.”

Implementations continue this cut to extract a composite convex polygon from multiple smaller convex polygons. Implementations may continue this process until there is no reflex point in the boundary vertices of the graph (or another termination criterion is met). In that case, the process is complete, and there may be chunks of convex polygons conglomerated into more giant convex polygons.

The techniques include the following. First, use a Breadth First Search (BFS) algorithm (or another approach) to construct a coplanar convex polygon graph based on the original mesh. Next, add the coplanar convex polygon graph into a queue. Note that while some example implementations discussed herein use queues (which are first-in-first-out (FIFO) containers) the techniques presented herein could be used with other data structures such as stacks (which are last-in-first-out (LIFO) containers) or other approaches for ordering operations. Then, calculate the graph boundary vertex angles with respect to the exact arithmetic. In the previous operation (graph construction), implementations only focus on the connectivity between the faces. Two faces are connected if they share at least an edge. Once the graph is created, implementations can deter which graph edges are boundary edges (boundary edges are edges where the other side's face has a different support plane than that of the graph's).

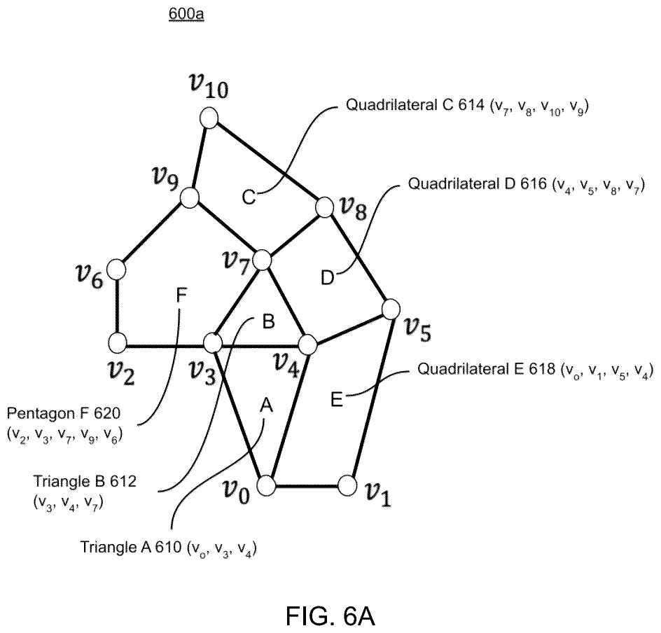

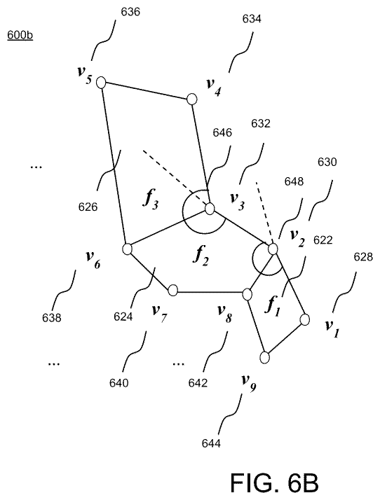

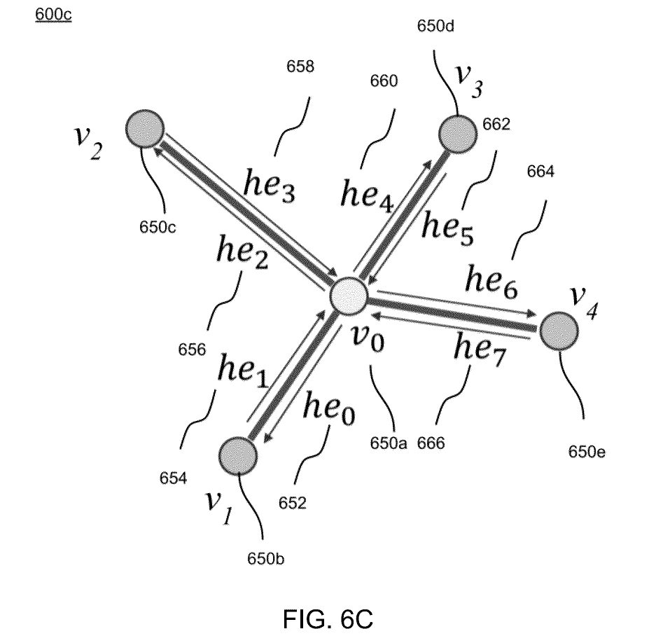

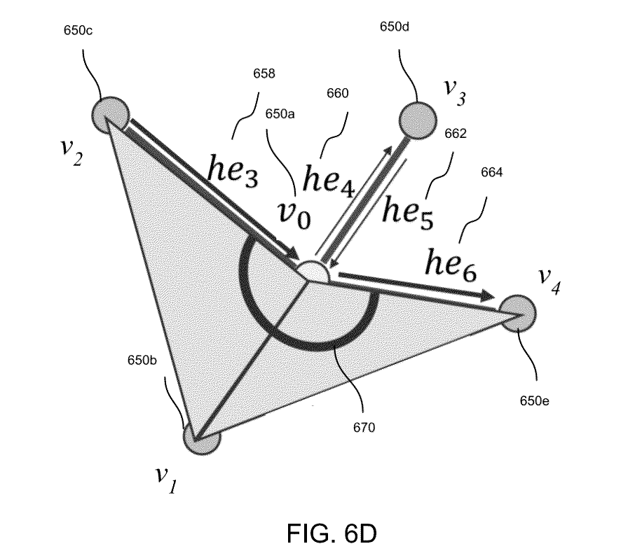

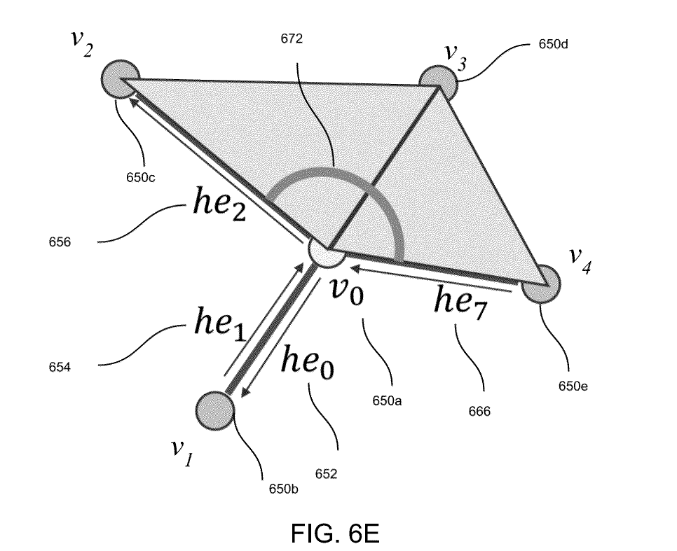

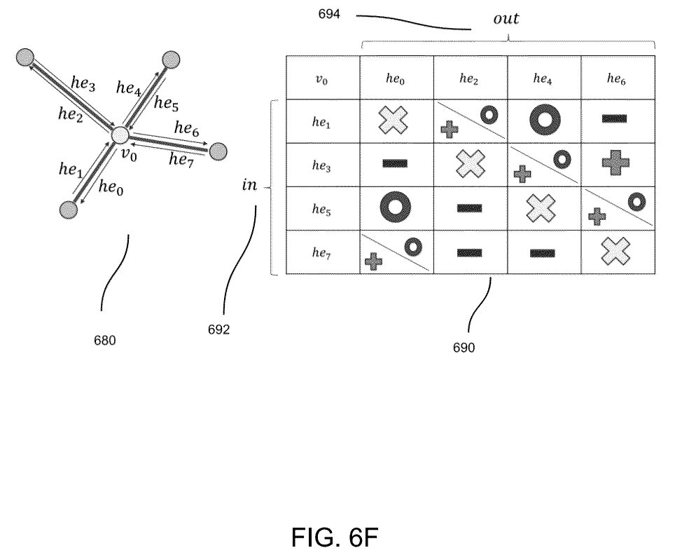

Next, implementations may follow the boundary path (which may always be a path of one or more closed paths) and check every vertex along the path to see if there are any reflex vertices for the graph with respect to the exact arithmetic. Such a check is discussed further with respect to FIGS. 6A-6B. If there is no such reflex point, implementations may merge the whole graph.

Else, choose a boundary reflex point as a starting point. Then, find the “straightest path” to another boundary vertex using a modified Dijkstra algorithm (or similar approach). In general, straightest path approaches could include any shortest path algorithm that can handle negative weights (e.g. Bellman-Ford). Split the graph along the path found in the previous step.

Finally, add the two subgraphs to the queue. The modified Dijkstra algorithm penalizes the path when cutting an internal graph vertex, residing a reflex boundary vertex in the subgraph, and rewards the path when the path resolves another boundary reflex vertex.

Other features may further optimize the performance of implementations. Calculating the angles at the vertices with respect to the exact arithmetic impacts CSG run-time performance. To minimize this effect, some implementations may use a circular table for each internal vertex of polygons in a given graph to calculate angles only once and reuse the table during the cutting operations. Also, some implementations may use logical inference techniques to deduce the convexity of an angle to reduce resource use by avoiding exact arithmetic calculations.

Additional details of such angle calculation are discussed further with respect to FIGS. 6A-6F. Summarized, there may be an “orientation” test that checks the position of the third vertex in a corner versus the position of the next vertex in the face of the second vertex in corner. If these two have the same position, the corner is convex, if they are different the corner is concave, and for collinear angles (π) the “orientation” test directly outputs a value of 0.

One or more termination conditions may be used. In some implementations, a termination condition corresponds to detecting that all of the subgraphs have no concave boundary vertices. However, some implementations utilize early termination criteria to keep the algorithm performing well in the cases where the optimal solution does not differ from the input itself, which means that there are no two faces that can be merged. In such a case it would be a waste of time to continue cutting operations until reaching the input itself. In another early termination criterion, a cutting operation does not merge many convex polygons. Other early termination criteria may be utilized to provide an appropriate balance between computing resource usage and optimality of results.

For example, in some implementations, an early termination criterion might be based on stopping when progress slows. For example, progress may be a metric based on a number of polygons that are cut at each iteration (e.g., with a threshold number of polygons being utilized, below which the progress is determined to be slow to determine that the termination criterion has been met). Progress might be a metric based on an estimated reduction in the requirement of computing resources for rendering is achieved after each cut.

There are some scenarios (e.g. like partially subtracting a one sphere from another) that make too many concave vertices and the optimal solution has that many concave vertices. In such cases, even though there might be two small faces that can be merged, it may be necessary to go into many cutting iterations before reaching to the point that only those two faces remain in a subgraph. In such a case spending that much amount of time is not worth the benefit that is obtained from merging those two small faces. Overall, by utilizing the described techniques, optimal or near-optimal solutions may be found for cases where an optimal solution exists.

The cutting algorithm is of linear time, having a complexity of O(n), which means that to find the optimal graph cutting path each edge is examined at most once. However, the overall algorithm is used with a divide and conquer approach. Similar to a merge sort algorithm, the sorting itself is linear but overall the time complexity is O(n log n). Similarly the present techniques linearly cut the graph into subgraphs. However, unlike merge sort it is not necessary to always continue to the end as progress is either stopped because of reaching an early stoppage criteria or the subgraphs becoming convex already. Thus, the time complexity of the present technique has a lower bound of O(n) and an upper bound of O(n log n).

Thus, in various implementations, when merging coplanar convex polygons, the described techniques provide ways to create a graph representing the polygons and cut the graph to form subsets of polygons, thereby finding a minimum (or close to a minimum) number of subsets in real-time (or near real-time) suitable for graphics rendering in applications such as gaming, virtual environments, or other graphics applications.

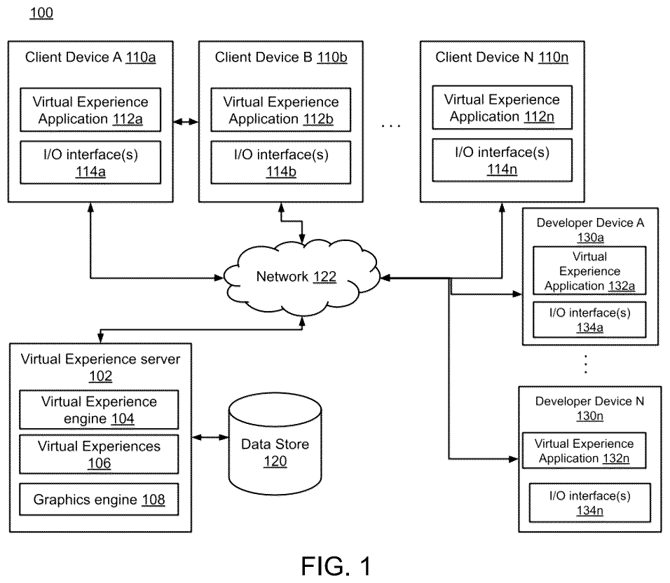

### FIG. 1—System Architecture

FIG. 1 is a diagram of an example system architecture that includes a 3D environment platform to merge coplanar convex polygons, in accordance with some implementations. FIG. 1 and the other figures use like reference numerals to identify similar elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g. “110” in the text refers to reference numerals “110a,” “110b,” and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client devices(s) 110 and developer device(s) 130 may refer to the same or same type of device.

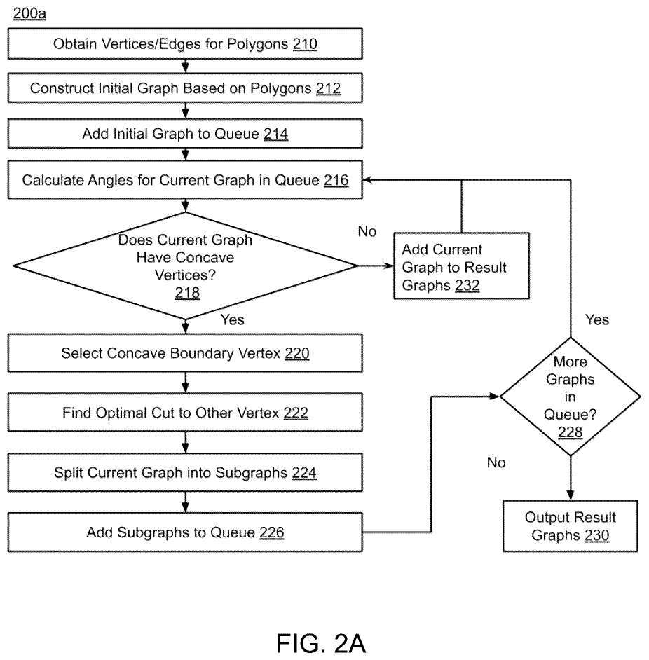

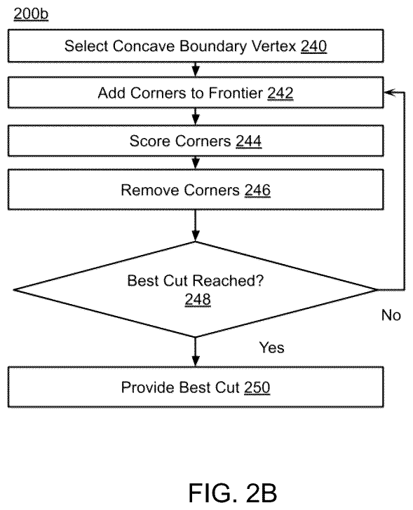

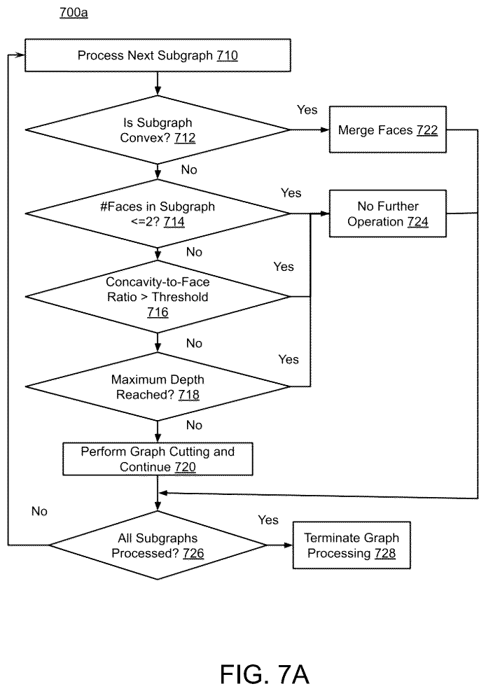

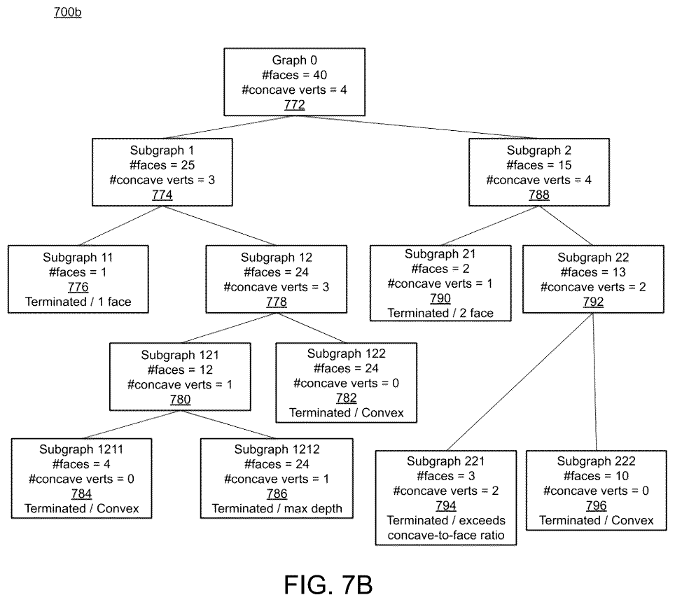

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 may perform one or more of the operations described below in connection with the flowcharts shown in FIGS. 2A-2B and 7A. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may also include multiple storage components (e.g., multiple drives or multiple databases) that may also span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata, e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 120 or within virtual experiences 106. The data store 120 may be utilized to store chat transcripts (text, audio, images, etc.) exchanged between participants.

In some implementations, the chat transcripts are generated via virtual experience application 112 and/or virtual experience application 132 or and are stored in data store 120. The chat transcripts may include the chat content and associated metadata, e.g., text content of chat with each message having a corresponding sender and recipient(s); message formatting (e.g., bold, italics, loud, etc.); message timestamps; relative locations of participant avatar(s) within a virtual experience environment, accessories utilized by virtual experience participants, etc. In some implementations, the chat transcripts may include multilingual content, and messages in different languages from different sessions of a virtual experience may be stored in data store 120.

In some implementations, chat transcripts may be stored in the form of conversations between participants based on the timestamps. In some implementations, the chat transcripts may be stored based on the originator of the message(s).

In some implementations of the disclosure, a “user” may be represented as a single individual. However, other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 102 may be a virtual gaming server. For example, the gaming server may provide single-player or multiplayer games to a community of users that may access as “system” herein) includes online virtual experience server 102, data store 120, client or interact with virtual experiences using client devices 110 via network 122. In some implementations, virtual experiences (including virtual realms or worlds, virtual games, other computer-simulated environments) may be two-dimensional (2D) virtual experiences, three-dimensional (3D) virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in real-time with other users of the virtual experience.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments” or “virtual environments” herein) where multiple environments may be linked. An example of an environment may be a three-dimensional (3D) environment. The one or more environments of a virtual experience 106 may be collectively referred to as a “world” or “virtual experience world” or “gaming world” or “virtual world” or “universe” herein. An example of a world may be a 3D world of a virtual experience 106. For example, a user may build a virtual environment that is linked to another virtual environment created by another user. A character of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects” or “virtual experience item(s)” herein) of virtual experiences 106.

For example, in generating user-generated virtual items, users may create characters, decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experience applications 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine/application (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 exceeds a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send experience instructions (e.g., position and velocity information of the characters participating in the group experience or commands, such as rendering commands, collision commands, etc.) to the client devices 110 based on control instructions. For instance, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a user's character within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g. shoulder and hip ratio); head size; etc.

One or more characters (also referred to as an “avatar” or “model” herein) may be associated with a user where the user may control the character to facilitate a user's interaction with the virtual experience 106.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types, e.g. shirts, pants, etc. the online virtual experience platform may provide users access to simplified 3D virtual object models that are represented by a mesh of a low polygon count, e.g. between about 20 and about 30 polygons.

In some implementations, the user may also control the scale (e.g., height, width, or depth) of a character or the scale of components of a character. In some implementations, the user may control the proportions of a character (e.g., blocky, anatomical, etc.). It may be noted that is some implementations, a character may not include a character virtual experience object (e.g., body parts, etc.) but the user may control the character (without the character virtual experience object) to facilitate the user's interaction with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a corner-wedge, a torus, a tube, a channel, etc. In some implementations, a creator module may publish a user's character for view or use by other users of the online virtual experience server 102. In some implementations, creating, modifying, or customizing characters, other virtual experience objects, virtual experiences 106, or virtual experience environments may be performed by a user using a I/O interface (e.g., developer interface) and with or without scripting (or with or without an application programming interface (API)). It may be noted that for purposes of illustration, characters are described as having a humanoid form. It may further be noted that characters may have any form such as a vehicle, animal, inanimate object, or other creative form.

In some implementations, the online virtual experience server 102 may store characters created by users in the data store 120. In some implementations, the online virtual experience server 102 maintains a character catalog and virtual experience catalog that may be presented to users. In some implementations, the virtual experience catalog includes images of virtual experiences stored on the online virtual experience server 102. In addition, a user may select a character (e.g., a character created by the user or other user) from the character catalog to participate in the chosen virtual experience. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to client device 110 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application may be an online virtual experience server application for users to build, create, edit, upload content to the online virtual experience server 102 as well as interact with online virtual experience server 102 (e.g., engage in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to developer device 130 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application 132 may be an online virtual experience server application for users to build, create, edit, upload content to the online virtual experience server 102 as well as interact with online virtual experience server 102 (e.g., provide and/or engage in virtual experiences 106 hosted by online virtual experience server 102). As such, the virtual experience application may be provided to the developer device(s) 130 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with appropriate credentials, a virtual experience developer may obtain access to virtual experience virtual objects, such as in-platform currency (e.g., virtual currency), avatars, special powers, accessories, that are owned by or associated with other users.

In general, functions described in one implementation as being performed by the online virtual experience server 102 can also be performed by the client device(s) 110, or a server, in other implementations if appropriate. In addition, the functionality attributed to a particular component can be performed by different or multiple components operating together. The online virtual experience server 102 can also be accessed as a service provided to other systems or devices through suitable application programming interfaces (APIs), and thus is not limited to use in websites.

### FIG. 2A—Merging Coplanar Convex Polygons

FIG. 2A is a flowchart of a method 200a to merge coplanar convex polygons in Constructive Solid Geometry (CSG), in accordance with some implementations. The method 200a provides a way to construct a graph representing part of a model and process the graph to merge subgraphs to simplify processing portions of the graph with concave vertices. The method 200a begins at block 210.

At block 210, vertices and edges for polygons are obtained. In some implementations, this information may be obtained from a CSG, such that a mesh associated with the polygons provides the vertices and edges. The vertex and edge information may be represented in various ways. For example, the vertices could be represented by coordinates in a three-dimensional space or in a two-dimensional space. The edges may include information about which vertices the edges connect. The vertex and edge information may also include vector information. The vertex and edge information may also include information about edge lengths and angles for the polygons. Block 210 may be followed by block 212.

At block 212, an initial graph may be constructed based on the polygon information. One approach is to use a breadth-first search (BFS), starting from a given polygon and adding polygons until all exterior edges of added polygons are boundary edges. As an alternative, implementations may use a depth-first search (DFS), which operates in a different order but provides the same result. An edge is a boundary edge if its opposite half-edge belongs to a face with an intersecting (non-coplanar) plane. However, this is only an example, and other approaches may be used to construct the graph. The initial graph may include relative positions of the vertices. The initial graph may also include edge lengths and/or angles. Such information permits the initial graph to have sufficient information to cut the initial graph into subgraphs. Block 212 may be followed by block 214.

At block 214, the initial graph is added to a queue. Such a queue may only include the initial graph. However, as the method 200a continues, subgraphs are introduced into the queue for additional cutting if the subgraphs include concave boundary vertices. Block 214 may be followed by block 216.

At block 216, angles are calculated for the current graph in the queue. The current graph here may refer to the graph on top of the queue. Such angle calculation may occur in a variety of ways. For example, such angle calculation is possibly performed using exact arithmetic.

To ensure optimal performance, it may be possible to calculate angles once and store them in a circular table for reuse for individual polygons. Additional details of such calculating angles, storing them in a circular table, and providing for reuse of the angles are discussed further, herein. Basically, this process uses logical inference to perform the angle convexity test using a minimal amount of resources. For example, if implementations go around a vertex and calculate possible angles, the processing passes a point at which an edge is collinear with the starting edge, all angles beyond that edge are concave, without any need for calculation. Block 216 may be followed by block 218.

At block 218, it is determined, for the current graph in the queue, whether the current graph has concave boundary vertices. At block 216, the polygons are associated with interior angles and these interior angles may help determine angles for boundary vertices. One approach to determining if there are concave boundary vertices is to check each boundary vertex and sum the applicable angles, and then establish if one or more of these angles exceeds π radians (180°). However, other tests for concave vertices may also be used, e.g., as described with reference to FIGS. 6A-6F (e.g., various tests to characterize vertices based on angle measures and other techniques such as exact arithmetic). If the current graph has at least one concave boundary vertex, block 218 is followed by block 220. Otherwise, block 218 is followed by block 232.

At block 220, a concave boundary vertex is selected. For example, it may be previously established that a concave boundary vertex exists. If it is not previously established specifically which boundary vertices are concave, at block 220, at least one concave boundary vertex is identified. From identified concave boundary vertices, one is chosen. Such a choice may be arbitrary (e.g., a vertex may be randomly selected) or may be based on other factors such as an angle measurement at the given vertex, a number of internal vertices to which the given vertex is connected, and so on.

Because implementations may just choose a random concave boundary vertex as the origin of the cut, it may not be possible to ensure in advance that one choice of vertex is better than another. However, an alternative approach may include choosing a concave boundary vertex that has many internal vertices connected to it may provide more branching for the path finding from that root concave vertex. It may help to explore paths in the graph to possibly find a cut that ends up providing better subgraphs that leads a nearer, more optimal solution. However, this is only a possible way of obtaining a better solution and is not guaranteed to obtain a better solution. Block 220 may be followed by block 222.

At block 222, an optimal cut from the selected concave boundary vertex to another boundary vertex is found. Such an optimal cut may be found using an approach described with reference to FIGS. 2B, 3A-3E, 4A-4C, and 5A-5B. Block 222 may be followed by block 224.

At block 224, the current graph is split into subgraphs. Such a split is along the optimal cut. Each subgraph may include at least one polygon. Such subgraphs may no longer include concave boundary vertices, at which point that subgraph is subject to no further processing. In the case that the number of faces in the subgraph is more than one, all faces in the subgraph will be merged into one face. Here, no further processing indicates that no further cutting is needed. Alternatively, the subgraphs may continue to include concave boundary vertices, and hence the subgraphs are further split. Block 224 may be followed by block 226.

At block 226, the subgraphs are added to the queue. These subgraphs may subsequently be further considered for splitting before the subgraphs are added as result graphs. Block 226 may be followed by block 228.

At block 228, it is determined if there are more graphs in the queue. If there is at least one graph in the queue, the queue is to be processed further. Accordingly, block 228 is followed by block 216. If not, the splitting is complete and block 228 is followed by block 230.

At block 230, the result graphs are output based on the processing. For example, the result graphs may be output including the information from the graph itself, such as vertex information (such as locations), edge information (lengths, angles, etc.), and so on. The method 200a presented in FIG. 2A illustrates cutting the graph until all of the concave boundary vertices are resolved.

However, in various implementations, cutting may stop earlier if one or more of various termination criteria are met. In such implementations, evaluation of termination criteria may be performed, e.g., after block 222, after block 228, or at other suitable points in the flow. Thus, the techniques end if all of the subgraphs have no boundary concave vertex. As a first example of additional stoppage criteria, cutting may stop if cutting reaches a depth limit that, if reached, no further cutting occurs beyond the depth limit. As a second example of additional stoppage criteria, cutting may stop if the ratio of boundary concave vertices to the number of faces is more than a sum of ratios.

At block 232, a current graph is added to a set of result graphs. Block 232 is based on a determination at block 218 that the current graph lacks concave boundary vertices. Hence, no cutting is appropriate, and the current graph is a subset of the convex polygons that is ready as a member of the result graphs. Further, once block 232 is reached, the current graph is fully considered and does not involve cutting.

### FIG. 2B—Cutting Coplanar Convex Polygons

FIG. 2B is a flowchart of a method 200b for finding a cut for coplanar convex polygons in Constructive Solid Geometry (CSG), in accordance with some implementations. The method 200b may begin at block 240.

At block 240, a concave boundary vertex of a convex polygon is selected. For example, block 240 may correspond to block 220 of FIG. 2A. As noted, such a concave boundary vertex may be selected arbitrarily or based on criteria (optionally, in that arbitrary vertex selection suffices). Block 240 may be followed by block 242. Blocks 242 to 250 may correspond to block 222 of FIG. 2B.

At block 242, corners are added to a frontier. The frontier refers to vertices in the graph for whom a path, but not necessarily an optimal path, has been found from the starting vertex. Corners are added to the frontier such that corners that extend the frontier are added for consideration. For example, corners extend the frontier by taking endpoints of previous corners and finding corners such that those previous corners add an additional edge. Block 242 may be followed by block 244.

At block 244, corners are scored. For example, a corner may be scored as +1, 0, or −1. A corner that introduces a concave boundary vertex is penalized with a score of +1. A corner that resolves a concave boundary vertex is rewarded with a score of −1. A corner that does neither of these things is provided with a score of 0. It may also be possible to change the penalty/reward.

The minimum points for a path may be −1 as a path can only possibly resolve one end concave boundary vertex, at a maximum. However, there is no upper bound for the past cost. While a positive path cost may only be +1, there is no upper bound for the path cost and the path cost may grow without limit depending on the specific circumstances of a given path (e.g., a positive path cost could be a greater positive integer). Block 244 may be followed by block 246.

At block 246, corners are removed from the frontier. If a previous path has less cost, it exists in the frontier, and the path with higher cost is removed from the frontier. For example, suppose that a given vertex has been reached with a path defined by a series of corners at a cost of −1. If the cost to reach that vertex from a path in the frontier is 0, that path may be removed from the frontier because it is established that it has a higher cost. Block 246 may be followed by block 248.

At block 248, it is determined if a best cut is reached (i.e., a cut that optimizes cost is identified). If a path to a boundary vertex exists whose cost is better than or equal to a cost for other paths to boundary vertices, that path is taken as the best cut. If multiple cuts exist with a same cost, any of these cuts may be used as the best cut. Such a best cut may not be a part of the actual optimal cut for the initial graph. However, such a cut may produce subgraphs that result in optimal or near-optimal results quickly.

If the best cut is reached, block 248 is followed by block 250. If not, block 248 is followed by block 242. In such a situation, further cutting is appropriate to generate the best cut.

At block 250, it has been established that a best cut has been reached. Accordingly, the best cut is provided at block 250. For example, the best cut may be used at block 224 in FIG. 2A to split the graph into subgraphs.

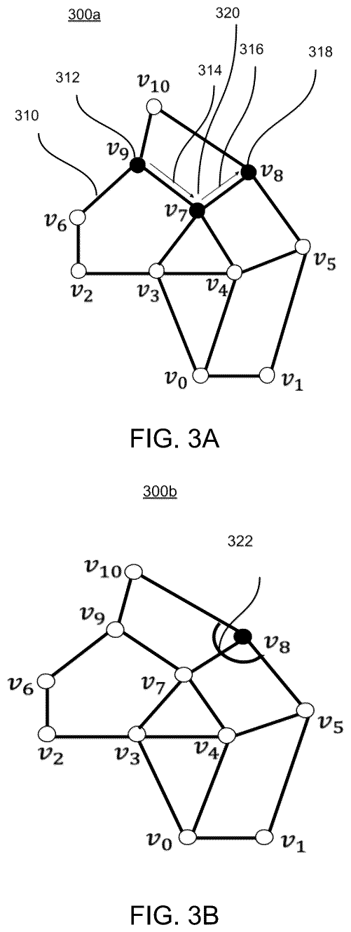

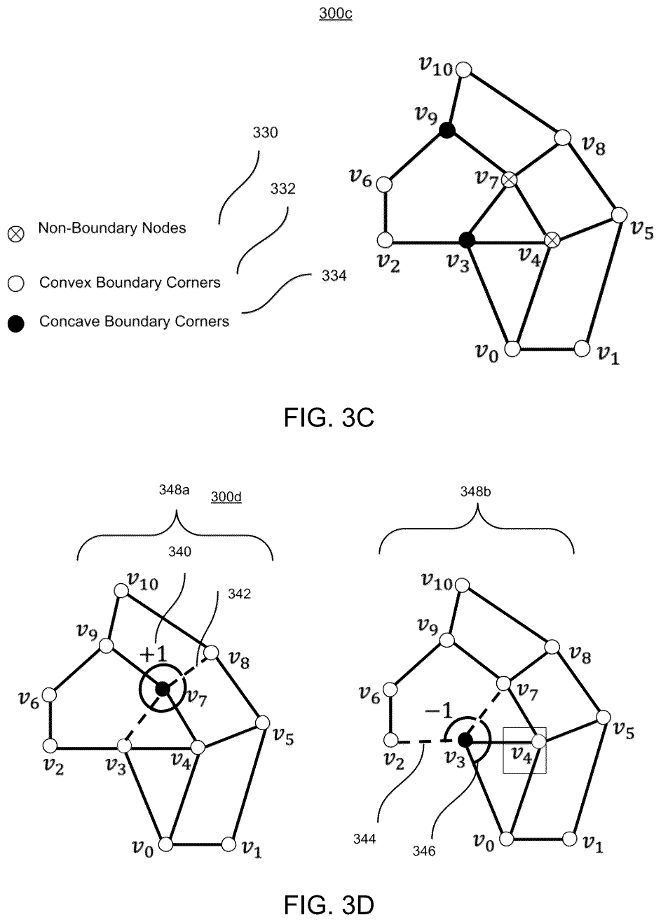

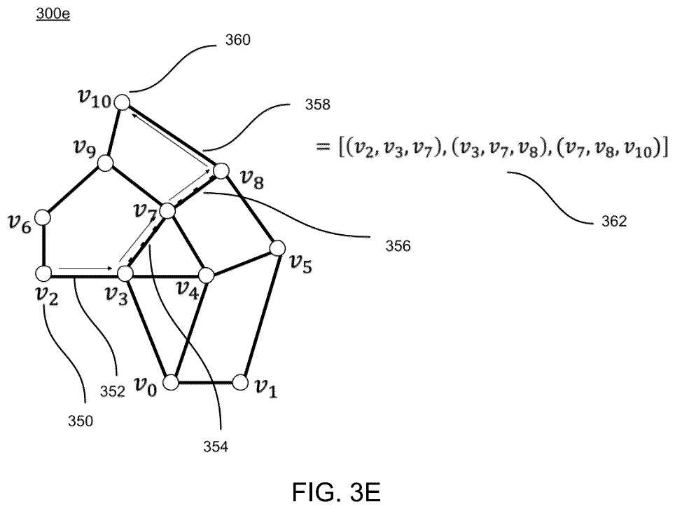

### FIG. 3A—Example Corner in Graph

FIG. 3A is a diagram 300a illustrating a corner in a graph, in accordance with some implementations. The graph 310 includes eleven vertices (v₀, v₁, v₂, v₃, v₄, v₅, v₆, v₇, v₈, v₉, v₁₀). These vertices are connected by edges, as illustrated in FIG. 3A. The edges define several coplanar convex polygons.

The cutting algorithm explores corners rather than vertices. Instead of joining convex shapes, the cutting algorithm cuts the mesh from a vertex at which a concavity begins. A corner refers to a path of non-boundary half-edges of length=2. A half-edge is an edge split along its length, having a directional component. That is, a half-edge has a beginning vertex and an end vertex.

FIG. 3A illustrates an example of a corner. A corner may begin at a starting vertex v₉ 312. The corner may include half-edge 314 and half-edge 316. Half-edge 314 joins starting vertex v₉ 312 to ending vertex v₇ 320. Half-edge 316 joins starting vertex v₇ 320 to ending vertex v₈ 318. Thus, the corner illustrated in FIG. 3A connects vertices v₉, v₇, v₈ (in that order). Corners may be represented using a 3-tuple, such as (v₉, v₇, v₈). The order of vertices in the corner is the order in which the vertices are traversed in a graph. An edge is a boundary edge if its opposite half-edge belongs to a face with an intersecting (non-coplanar) plane. Likewise, a vertex is a boundary vertex if that vertex is connected to at least two boundary edges.

### FIG. 3B—Convex Boundary Vertex in Graph

FIG. 3B is a diagram 300b illustrating a convex boundary corner 322 in a graph, in accordance with some implementations. Convex boundary corner is a convex boundary corner because the sum of the constituent angles is less than or equal to π radians (180°). For example, the convex boundary corner illustrated in FIG. 3B connects vertices v₁₀, v₈, and v₅.

The middle vertex is v₈, which forms angles with v₇, and v₁₀, as well as with v₇ and v₅. The angle formed by v₇, v₈, and v₁₀ is roughly 80°. The angle formed by v₇, v₈, and v₅ is roughly 85°. Thus, these angles sum to roughly 165°. Accordingly, the sum of the angles is less than π radians (180°) and convex boundary corner 322 is considered to be a convex boundary corner. However, a boundary corner may have a total angle that is equal to π radians (180°) and still be considered a convex boundary corner.

### FIG. 3C—Examples of Convex Boundary Corners and Concave Boundary Corners in Graph

FIG. 3C is a diagram 300c illustrating convex boundary corners and concave boundary corners, in accordance with some implementations. The corners are indicated by the vertex that forms the center of a given corner. For example, the corners having centers at vertices v₀, v₁, v₂, Vs, v₆, v₈, and v₁₀, are considered to be convex boundary corners 332. By contrast, the boundary corners having centers at vertices v₃ and v₉, are considered to be concave boundary corners 334.

For example, vertex v₃ includes three interior angles: the angle formed by v₂, v₃, and v₇, which is roughly 135°, the angle formed by v₇, v₃, and v₄, which is roughly 45°, and the angle formed by v₄, v₃, and v₀, which is roughly 50°. Thus, these angles sum to roughly 230°. The combinations of vertices may also create angles, such as the angle formed by v₂, v₃, and v₄ and the angle formed by v₇, v₃, and v₀. Accordingly, the sum of these angles is greater than 180°. Hence, the boundary corner associated with vertex v₃ is considered to be a concave boundary corner. Vertices v₄ and v₇ are internal vertices, and hence are considered part of neither convex nor concave corners. Thus, these vertices are labeled as being non-boundary nodes 330.

### FIG. 3D—Penalizing and Rewarding Corners in Graph

FIG. 3D is a diagram 300d illustrating penalizing and rewarding corners, in accordance with some implementations. When processing graphs, the processing merges graphs into subgraphs of connected coplanar polygons. The processing continues with each subgraph until all of the subgraphs are convex subgraphs. A connected graph is convex if all of its boundary vertices are convex.

In general, corners are scored to progressively eliminate concave boundary vertices. For example, FIG. 3D illustrates two corners in examples of a graph. For example, a first graph 348a illustrates a penalized first corner 342. A second graph 348b illustrates a rewarded second corner 344.

For example, the first graph 348a illustrates the penalized first corner 342. The penalized first corner 342 is the corner (v₃, v₇, v₈). However, this first corner 342 is associated with a penalty 340 (which may be a score of +1). The first corner 342 forms two angles between vertices (v₃, v₇, v₈). While on one side of the first corner 342, the angles are less than 180°, on the other side of the first corner 342, the angles between (v₃, v₇, v₉) and between (v₉, v₇, v₈) are greater than 180°.

Hence, this first corner 342 creates another concave boundary vertex at v₇ and the corner is penalized by penalty 340. The vertex v₇ was an internal vertex before the cut at corner (v₃, v₇, v₈). The cut makes two boundary corners at the two subgraphs where one is convex and the other concave. The +1 penalty 340 is given because of the introduction of one concave vertex.

By contrast, the second graph 348b illustrates a rewarded second corner 344. The rewarded second corner 344 between (v₂, v₃, v₇) resolves a concave boundary vertex at v₇ and the second corner 344 is rewarded. The vertex v₃ was a concave boundary vertex before the cut at corner (v₂, v₃, v₇). The cut makes two boundary vertices at the two subgraphs where both are convex boundary vertices. The −1 reward is given because of the reduction of the one concave vertex.

### FIG. 3E—Example Cut as Series of Corners

FIG. 3E is a diagram 300e illustrating representing a cut as a series of corners, in accordance with some implementations. A candidate cut in a graph is a path that starts and ends at boundary vertices. To clarify, the definition that start and end points for a cut be boundary vertices means that the midpoints of the initial and final corners are to be boundary vertices. A cut may be represented as a sequence of corners. For example, FIG. 3E illustrates a cut from vertex v₂ 350 to vertex v₁₀ 360. The cut is a series of corners forming a path along half-edges connecting v₂, v₃, v₇, v₈, and v₁₀, in that order. A cut bisects the graph being cut into two subgraphs and may introduce new concave vertices.

For example, the corners may include half-edge 352 from v₂ to v₃, half-edge 354 from v₃ to v₇, half-edge 356 from v₇ to v₈, and half-edge 358 from v₈ to v₁₀. Hence, the corners in this path 362 are [(v₂, v₃, v₇), (v₃, v₇, v₈), (v₇, v₈, v₁₀)]. The relevant boundary vertices are v₃ and v₈. The cost of a cut is the sum of the cost of its corners.

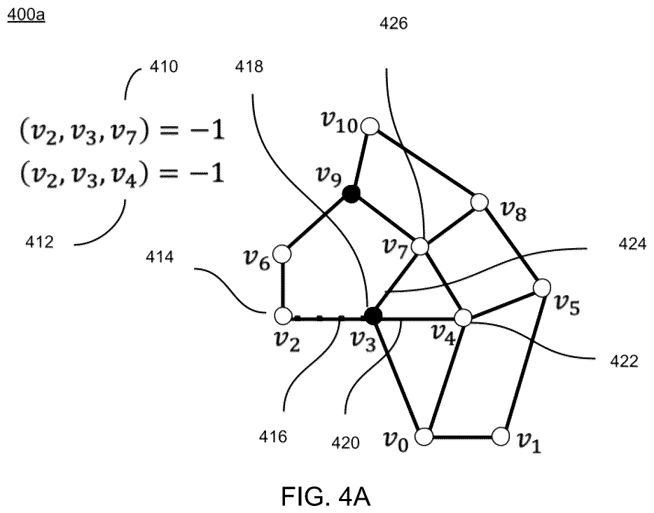

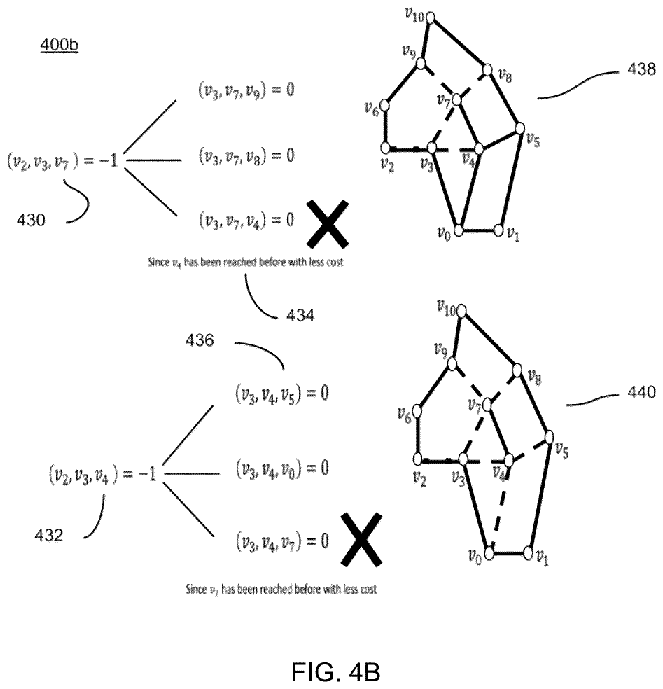

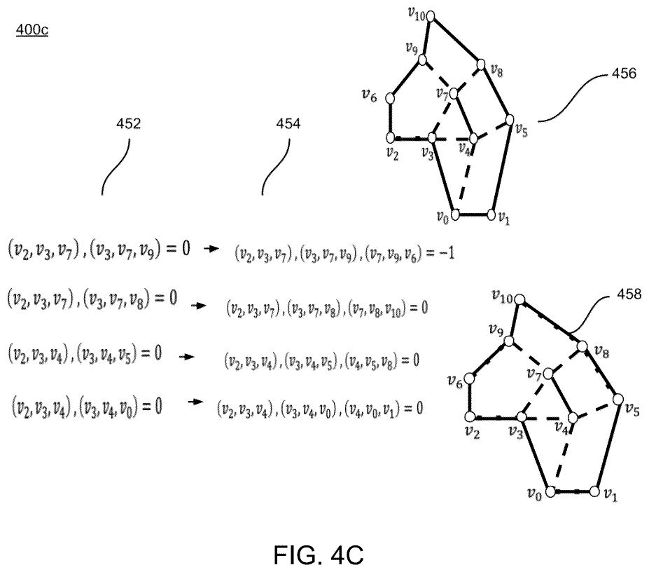

### FIG. 4A—Example Corners Associated with Rewards in Cutting Algorithm

FIG. 4A is a diagram 400a illustrating corners associated with rewards in a cutting algorithm, in accordance with some implementations. The algorithm starts from a concave boundary vertex. If no concave boundary vertex exists, the algorithm is irrelevant. The algorithm begins by adding corners that include the concave boundary vertex to the frontier. Specifically, the algorithm adds corner 410 (v₂, v₃, v₇) and corner 412 (v₂, v₃, v₄) because each of these corners start from v₃ and have an equal cost to reach (which may be −1). Likewise, v₄ and v₇ are internal vertices.

For example, FIG. 4A illustrates that corner 410 and corner 412 each include half-edge 416 from vertex v₂ 414 to vertex v₃ 418. Corner 410 further includes half-edge 424 from vertex v₃ 418 to vertex v₇ 426. Corner 412 further includes half-edge 420 from vertex v₃ 418 to vertex v₄ 422. Because corner 410 and corner 412 each resolve vertex v₃ 418 by resolving the angle at that vertex, corner 410 and corner 412 are each associated with a score of −1.

### FIG. 4B—Finding Cut by Eliminating Corners

FIG. 4B is a diagram 400b illustrating finding a cut by eliminating corners, in accordance with some implementations. For example, FIG. 4B illustrates corner 410 (v₂, v₃, v₇) and corner 412 (v₂, v₃, v₄) because these are the corners on the frontier. Corner 410 is associated with frontier corners 434 and corner 412 is associated with frontier corners 436. Frontier corners 434 correspond to graph 438. Frontier corners 436 correspond to graph 440. For example, frontier corners 434 include (v₃, v₇, v₉), (v₃, v₇, v₈), and (v₃, v₇, v₄). Frontier corners 436 include (v₃, v₄, Vs), (v₃, v₄, v₀), and (v₃, v₄, v₇).

Each of these frontier corners 434 are associated with a score of +1, in that concave boundary vertices are created by using these corners. Frontier corners 434 thus provide ways to reach v₉ and v₈ with a total cost of 0. However, (v₃, v₇, v₄) may be discarded in that it is already possible to reach v₄ with a total cost of −1.

Each of these frontier corners 436 are associated with a score of +1, in that concave boundary vertices are created by using these corners. Frontier corners 434 thus provide ways to reach v₅ and v₀ with a total cost of 0. However, (v₃, v₄, v₇) may be discarded in that it is already possible to reach v₇ with a total cost of −1.

### FIG. 4C—Further Aspects of Finding a Cut

FIG. 4C is a diagram 400c illustrating further aspects of finding a cut, in accordance with some implementations. For example, paths 452 include paths (v₂, v₃, v₇), (v₃, v₇, v₉), and (v₂, v₃, v₇), (v₃, v₇, v₈). Paths 452 also include (v₂, v₃, v₄), (v₃, v₄, v₅), and (v₂, v₃, v₄), (v₃, v₄, v₀). Each of these paths 452 corresponds to partial paths in graph 456.

In the next iteration, paths 452 generate cuts (v₂, v₃, v₇), (v₃, v₇, v₉), (v₇, v₉, v₆) with a total score of −1, (v₂, v₃, v₇), (v₃, v₇, v₈), (v₇, v₈, v₁₀) with a total score of 0, (v₂, v₃, v₄), (v₃, v₄, v₅), (v₄, v₅, v₈) with a total score of 0, and (v₂, v₃, v₄), (v₃, v₄, v₀), (v₄, v₀, v₁) with a total score of 0. Hence, cut (v₂, v₃, v₇), (v₃, v₇, v₉), (v₇, v₉, v₆) is provided by the algorithm to divide the original graph, as it has the best score. If two cuts with the same score result, a cut may be chosen arbitrarily or based on a criterion, such as an aspect of a number of polygons in subgraphs resulting from the selected cut.

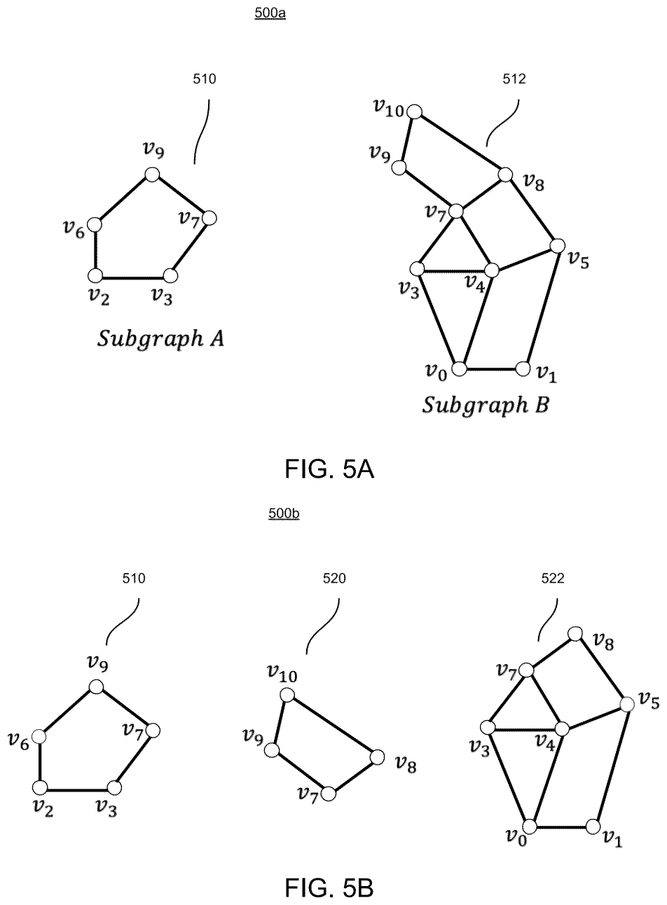

### FIG. 5A—Initial Subgraphs Generated by a Cut

FIG. 5A is a diagram 500a illustrating examples of subgraphs generated by a cut, in accordance with some implementations. For example, FIG. 5A illustrates how the original graph may be cut into subgraph A 510 and subgraph B 512. Subgraph A 510 is a pentagon defined by original vertices v₂, v₃, v₇, v₉ and v₆. Subgraph A 510 does not require additional processing. First, there is only one polygon remaining. Further, that polygon does not have any concave vertices. This property is guaranteed because a single polygon would not have been part of the graph if that polygon were not convex. Alternatively put, a precondition is that every individual polygon may be convex. Hence, reducing a graph to a single polygon may be a stopping condition.

However, subgraph B 512 is a subgraph that requires further processing. For example, subgraph B 512 includes three quadrilaterals and two triangles. While each of these individual polygons is convex, subgraph B 512 still includes a concave boundary corner, specifically the corner (v₃, v₇, v₉), centered at vertex v₇.

### FIG. 5B—Final Subgraphs Generated by a Cut

FIG. 5B is a diagram 500b illustrating examples of final subgraphs corresponding to an original graph, in accordance with some implementations. Subgraph A 510 from FIG. 5A remains the same, in that subgraph A 510 has no further concave boundary corners and includes only a single polygon. However, subgraph B 512 (illustrated in FIG. 5A) has been split further, into two subgraphs, subgraph C 520 and subgraph D 522.

Subgraph C 520 is clearly finished, in that subgraph C 520 includes a single polygon, specifically a quadrilateral formed by v₁₀, v₉, v₇, v₈. However, subgraph D 522 is also complete. Subgraph D 522 includes four polygons, including two triangles and two quadrilaterals. However, subgraph D 522 does not include any concave boundary vertices. Hence, it is not appropriate to cut subgraph D 522 any further. This graph is converted into a new single convex polygon.

### FIG. 6A—Example Polygons in a Graph

FIG. 6A is a diagram 600a illustrating examples of polygons in a graph, in accordance with some implementations. For example, FIG. 6A illustrates triangle A 610 (v₀, v₃, v₄), triangle B (v₃, v₄, v₇), quadrilateral C 614 (v₇, v₈, v₁₀, v₉), quadrilateral D 616 (v₄, v₅, v₈, v₇), quadrilateral E 618 (v₀, v₁, v₅, v₄), and pentagon F 620 (v₂, v₃, v₇, v₉, v₆).

Each of these polygons is convex. When building the graph, the graph indicates which vertices are connected to which other vertices by edges. In some implementations, the graph includes information about vertex locations. These vertex locations may allow these implementations to infer angle characteristics for polygons in the graph. Computing angle characteristics may be performed using exact arithmetic to avoid rounding errors. The inferred angle characteristics allow for identification of which vertices are convex boundary vertices and which are concave boundary vertices.

### FIG. 6B—Example of Checking if Graph Boundary Vertex is Concave or Concave Using Exact Arithmetic

FIG. 6B is a diagram 600b illustrating checking convexity and concavity for angles for a polygon in a graph, in accordance with some implementations.

The exact arithmetic becomes an issue in implementations because all computations are performed using floating-point arithmetic in a computer. In mathematics, real numbers (3) include both rational and irrational numbers. The rational numbers may be written in decimal format with a finite number of digits, while irrational numbers would use an indefinite number of digits to be correctly represented in decimal form. For example, ½ (one-half) is a rational number (it may be expressed as 0.5, which is a finite number of digits) and an example irrational number is π. π may be approximated as 3.14159, but to fully express π would require an infinite number of decimal digits with no specific repeating pattern.

However, in computer arithmetic, processors can only allocate a finite space for representing a number. For real numbers, the closest format is a floating point number representation that is mostly follows a standard. For example, a common floating point standard is (IEEE 754). The standard provides the ability to represent a decimal number in the form of 1.d₁d₂ . . . dₚ×10^{e}, where p is the number of precision digits for the decimal and e is the exponent that is also limited to the number of bits allocated to represent. Considering this limitation, irrational numbers cannot be represented exactly using a floating point number as an irrational number would use an infinite number of digits. Also, any rational numbers that use more than p digits to be exactly represented are also truncated in this format.

In many computer applications, such a limitation is not problematic as the decisions made by the applications do not rely on exact values resulting from arithmetic operations. In computational geometry, however, relying on the results of arithmetic operations calculated using floating point numbers may cause topological inconsistency. One major issue that is raised by such a limitation in geometry is the orientation predicate. This issue is explained herein in 2D, and the discussion may be easily extended to 3D space. A line in the 2D space bisects the space into two sub-spaces, say in front of and in back of the line. The position of a point in the 2D space can be either in front of the line, in back of the line, or exactly on the line.

Thus, the line l₀: a₀x+b₀y+c₀=0 splits the space. There may be points p₁, p₂, and p₃, that are in-front of the line, on the line, and in back of the line. Each point is defined as the intersection of two non-parallel lines. Assume each query point for which an orientation is desired is defined using two lines l_{q} and l′_{q}. According to linear algebra, the above orientation predicate can be determined by calculating the following 3×3 determinant, where each row represents a line equation.

$$\vert \begin{matrix}… & l & … \\ … & {l}_{q} & … \\ … & {l}_{q}^{′} & …\end{matrix} \vert = \vert \begin{matrix}{a}_{0} & {a}_{0} & {a}_{0} \\ {a}_{q} & {a}_{q} & {a}_{q} \\ {a}_{q}^{′} & {a}_{q}^{′} & {a}_{q}^{′}\end{matrix} \vert$$

The above approach works acceptably when using real number arithmetic (with the ability to represent a real number without approximation). However, the above approach is problematic when using the floating-point number representations in an actual computer. Various points may each have an orientation with respect to a line. Point orientation discrepancy (i.e., rounding error) occurs when considering the close neighborhood of a line. The rounding error makes it difficult to calculate the correct position of points if the point is very close to the line.

To resolve this issue, a technique may be utilized to overcome the above problem. This technique involves the following steps. First, computing an initial approximation of the determinant using standard floating-point arithmetic. This operation is fast but may be inaccurate for points that are nearly collinear (i.e., when the determinant calculated above is close to zero). Second, checking the error bound of the computed determinant. This operation involves estimating the potential error in the floating-point computation. If the error is small enough to guarantee the correctness of the sign, the technique returns this sign. Third, if the initial approximation is not sufficiently accurate, the technique adaptively increases the precision of the arithmetic. This adaptive increase is done by breaking the computation into smaller, exact steps using higher precision arithmetic. Then, the determinant is re-evaluated with an increased precision until the error is small enough to ensure a reliable sign.

The orientation problem discussed above and its management can easily be extended to a 3D space as instead of a line by use of planes in the 3D space. The first row of the relevant determinant is the plane equation and the next three rows intersect at the query point. As the plane equation in 3D space is in the form of ax+by +cz+d=0, these rows form a 4×4 determinant (instead of the 3×3 determinant discussed above).

For example, the exact arithmetic may be used to determine if an angle is convex. FIG. 6B shows part of a graph that has three polygons: f₁ 622, f₂ 624, and f₃ 626.

In FIG. 6B, there may be 3 coplanar faces (polygons) that may belong to a coplanar graph. All the faces are on the same 3D plane. Assume v₁, v₂, v₃, v₄ are on the boundary of the graph, while “ . . . ” means the edges are connected to other faces (e.g., for Us, v₆, v₇, v₈, v₉). The two corners (v₁, v₂, v₃) and (v₂, v₃, v₄) may be checked with respect to exact arithmetic. To make this check, the orientation 4×4 determinant may be used to test a query 3D point with respect to a 3D plane. Note that each edge is defined by intersection of two planes: one is the face plane, and the other is the edge plane.

For example, the edge (v₁, v₂) has a plane that defines itself against the plane of face f₁. Thus, the edge corresponding to the plane of (v₁, v₂) divides the 3D space such that the edge (v₁, v₂) itself is on that plane. The intersection of the plane of edge (v₁, v₂) with the graph plane is the edge itself and its continuation is shown as a dotted line.

On the other hand, it is clear that the corner of (v₁, v₂, v₈) is convex, because it belongs to face (polygon) and by construction, all polygons are convex. So, the corner (11, 12, 13) is convex if and only if the orientation of point v₃ is the same as orientation of point v₈ against the plane defined by the edge of (v₁, v₂). As shown in the drawing, both v₈ and v₃ are on the same side of the dotted line that is extended from the edge of (v₁, v₂).

The 4×4 determinant for calculating the orientation of v₃ with respect to the plane of (v₁, v₂) edge is the edge plane itself, and three planes that form v₃ which are: the plane of (v₂, v₃), the plane of (v₃, v₄) or (v₃, v₆), and the base plane. Also, the planes for the immediate next vertex point in the face (v₈) are the planes of edges (v₂, v₈) and (v₈, v₉). Similarly, for calculating the corner of (v₂, v₃, v₄) it is necessary to check if the orientation of vertices at v₄ and v₆ are the same or not.

Clearly from FIG. 6B, these vertices have different orientations and therefore the corner has a concave angle. Sometimes the boundary corners are neither convex nor concave, but they are on the line. This can easily be checked when the result of the determinant of the corner point is zero. In such a case, it is not necessary to calculate the orientation of the next immediate point in the face, as we know that the boundary has a perfect 180-degree angle. So, this is an early termination step and therefore we always calculate the orientation of the vertex in boundary first.

### FIG. 6C—Finding Convexity, Concavity, and Collinearity from Cut in a Graph

FIG. 6C is a diagram 600c illustrating examples of finding convexity, concavity, and collinearity of resulting angles from a cut, in accordance with some implementations.

FIG. 6C shows a central vertex v₀ 650a and four non-central vertices v₁ 650b, v₂ 650c v₃ 650d, v₄ 650e. Starting from a non-central vertex, a path may be followed along the central vertex and perform operations to find the convexity/concavity/collinearity of the resulting angle from the cut. FIG. 6C shows that v₀ 650a and v₁ 650b are connected by he₀ 652 and he₁ 654. FIG. 6C shows that v₀ 650a and v₂ 650c are connected by he₂ 656 and he₃ 658. FIG. 6C shows that v₀ 650a and v₃ 650d are connected by he₄ 660 and he₅ 662. FIG. 6C shows that v₀ and v₄ are connected by he₆ 664 and he₇ 666.

### FIG. 6D—Concave Angle Resulting from a Cut

FIG. 6D is a diagram illustrating a concave angle resulting from a cut, in accordance with some implementations. For example, FIG. 6D shows the cut (he₃, he₆) where half-edge he₃ 658 is followed by half-edge he₆ 664. FIG. 6D also shows the half-edges he₄ 660 and he₅ 662. The cut (he₃, he₆) starts at vertex v₂ 650c, passes through v₀ 650a, and terminates at vertex v₄ 650e. The cut (he₃, he₆) does not involve vertex v₁ 650b or vertex v₃ 650d.

### FIG. 6E—Convex Angle Resulting from a Cut

FIG. 6E is a diagram illustrating a convex angle resulting from a cut, in accordance with some implementations. For example, FIG. 6E shows the cut (he₇, he₂) where half-edge he₇ 666 is followed by half-edge he₂ 656. FIG. 6E also shows the half-edges he₀ 652 and he₁ 654. The cut (he₇, he₂) starts at vertex v₄ 650e, passes through v₀ 650a, and terminates at vertex v₂ 650c. The cut (he₇, he₂) does not involve vertex v₁ 650b or vertex v₃ 650d.

### FIG. 6F—Precomputed Table Obtained from Graph

FIG. 6F is a diagram illustrating a precomputed table obtained from a graph that stores information about angles in the graph, according to some implementations. The two corners (he₃, he₆) and (he₇, he₂) create a same two angles. Implementations must differentiate them. Because half-edges go counter-clockwise, the internal angle may be assigned for each corner. Because the sum of these two angles is 2π radians (or) 360°, if one angle is convex, the other is concave and vice versa. The graph is illustrated at 680.

Using the graph 680, it may be possible to generate table 690 that indicates what happens for a given half-edge in 692 and a given half-edge out 694. For example, table 690 shows a large X symbol at edges where the first edge and the second edge form a known angle of 2π radians or 360° (i.e., cells (i,i)). That is, he₁ to he₀, he₁ to he₀, he₃ to he₇, he₅ to he₄, and he₇ to he₆ are irrelevant.

The (i, i+1)'s (with modulus for symmetry) are always either convex or collinear, because the first immediate next half-edge belongs to the same face and is thus always convex. Next, it is needed to calculate the next angles row-wise. As the angle (i, j) is found, the angle value for (j, i) can also be deduced. For example, once it is found that (he₁, he₄) is collinear, it is then deduced that (he₅, he₀) is collinear and that (he₁, he₆) is concave. In the second row, (he₃, he₆) may be calculated. As this angle is convex, its opposite is deduced to be concave. However, the next angle (he₃, he₀) cannot be deduced at this point with the existing information. However, the options for this angle are limited to collinear or concave. Thus, it may be possible to test for collinearity. If the vertex is not collinear, then it is determined to be concave.

In the third row, as (he₅, he₀) is already deduced from the symmetry, (he₅, he₂) is deduced to be concave. Thus, no calculation is needed for the third row. Similarly, for the fourth row, there is no need for any additional calculations of any angle as any cells may be deduced based on existing information. In FIG. 6F, “+” means convex, “o” means collinear, and “−” means concave in the table.

### FIG. 7A—Providing Early Termination

FIG. 7A is a flowchart of a method 700a to detect and implement early termination conditions, in accordance with some implementations. The method 700a may begin at block 710. Ordinarily, as shown in FIG. 2A, graphs are cut into subgraphs until all of the subgraphs include entirely convex vertices. However, there may be conditions under which an early termination of the cutting is appropriate. FIG. 7A illustrates examples of such conditions and how they are implemented.

For example, there may be a series of termination criteria, tested for and identified in sequence. For example, one criterion may may be if a given subgraph is convex. If the subgraph has no concave boundary vertices, it is convex and all of its faces can be merged into one face. If the subgraph only has one face, a single face is already convex, and no further operation is needed. With two faces, when a subgraph includes two faces and there is still a concave boundary vertex, the next action is separating the subgraph into two faces. Even if no action is taken, the faces will still be there. It is not necessary to do anything. Additionally, the exploration is a binary tree. There may be a maximum depth at which cutting the subgraph stops if the cutting reaches the maximum depth.

At block 710, a next subgraph in the queue is processed. The next subgraph may either be an initial graph or a subgraph generated by cutting that initial graph. Block 710 may be followed by block 712.

At block 712, it is determined if the current subgraph is convex. If the current subgraph is convex, block 712 is followed by block 722. At block 722, the faces in the subgraph are merged. Block 722 may be followed by block 726. If the current subgraph is not convex, block 712 is followed by block 714.

At block 714, it is determined if a number of faces in the current subgraph is less than or equal to two. If the number of faces in the current subgraph is less than or equal to two, block 714 is followed by block 724. At block 724, no further operation occurs. Block 724 may be followed by block 726, at which it is determined if all subgraphs are processed. If the number of faces in the current subgraph is not less than or equal to two (i.e., there are at least three faces), block 714 is followed by block 716.

At block 716, it is determined if a concavity-to-face ratio is greater than a threshold. For example, the number of concave vertices may be divided by the number of faces, and the quotient may be compared to a threshold to define such a ratio. If the ratio is greater than the threshold, block 716 is followed by block 724. At block 724, no further operation occurs. Block 724 may be followed by block 726, at which it is determined if all subgraphs are processed. If the ratio is not greater than the threshold, block 716 is followed by block 718.

At block 718, it is determined if a maximum depth is reached. For example, the maximum depth may be a threshold tree depth after which cutting stops. For example, even if it is possible to stop cutting after a certain threshold tree depth (3, 4, 5, etc.) cutting may stop at a maximum depth to keep computational complexity manageable. If there are more significant computing resources, the maximum depth may be greater, in that it may be feasible to store the additional information necessary to keep cutting to a greater depth. If the maximum depth is reached, block 718 is followed by block 724. At block 724, not further operation occurs. Block 724 may be followed by block 726, at which it is determined if all subgraphs are processed. If the maximum depth is not reached, block 718 is followed by block 720.

At block 720, the graph cutting is performed and the method continues. Block 720 may be followed by block 726.

At block 726, it is determined if all of the subgraphs have been processed. If so, block 726 is followed by block 728. At block 728, the graph processing terminates. If not, block 726 is followed by block 710. At block 710, the next subgraph is processed.

Other stopping criteria may be considered as well and added to this method as appropriate. For example, it may be determined if an improved solution does not exist. The merging is intended to create a minimum number of subgraphs. If an improved solution does not exist, that is, one in which merging subgraphs would reduce a number of convex polygons, there may be no improved solution, and there may be early termination.

Note that the termination criterion only terminates the subgraph from expansion (cutting), not terminating the whole graph operation. The quality of one branch is independent from other independent branches. In practice, the “if condition blocks” are considered in this order. First, is the subgraph convex. If so, merge faces. If not, is the number of faces in the subgraphs less than or equal to two do nothing. If not, does a concavity-to-face-ratio exceed a threshold. If so, do nothing. If not, has the maximum depth been reached. If so, do nothing. If not, cut the graph and continue. These are the conditions that are checked at every node of the binary tree. There may also be some concern if progress is happening too slowly, or if there is another reason to stop the cutting.

Accordingly, early termination may occur based on any of determining that the queue is empty, determining that an amount of progress between consecutive executions of the cutting result in a less than threshold amount of progress, determining that an early termination threshold and/or condition is met, and determining that the queue is empty.

After an early termination, the optimal cut condition may not be met. However, even after early termination, there may be fewer concave boundary vertices in resulting subgraphs in that the cuts are performed in ways that resolve concave boundary vertices. The cut algorithm finds a cut that optimally or near-optimally resolves concave boundary vertices. Further, such results may be obtained quickly. To confirm actual optimal results would require a great deal of time. Hence, the results provided by these approaches are quick and generally good enough for the real-time applications that would use these approaches.

### FIG. 7B—Tree Structure and Processing Subgraphs

FIG. 7B is a diagram illustrating a tree structure and how subgraphs are processed 700b, in accordance with some implementations. For example, as a root, there may be Graph 0 772, with #faces=40 and #concave verts=4 (where #faces is the number of faces in a given graph and where #concave verts is the number of concave boundary vertices in a given graph). Graph 0 may be cut into Subgraph 1 774, with #faces=25 and #concave verts=3 and Subgraph 2 788, with #faces=15 and #concave verts=4.

Subgraph 1 774 may be cut into Subgraph 11 776 with #faces=1 (hence, no concave vertices) and Subgraph 12 778, with #faces=24 and #concave verts=3. Subgraph 11 776 may terminate cutting because it only includes one face. Subgraph 12 778 may be cut into Subgraph 121 780, with #faces=12 and #concave verts=1 and Subgraph 122 782, with #faces=24 and #concave verts=0. Subgraph 122 782 may terminate cutting because it is convex (as implied because it has no concave vertices). Subgraph 121 780 may be cut into Subgraph 1211 784, with #faces=4 and #concave verts=0 and Subgraph 1212 786, with #faces=24 and #concave verts=1. Subgraph 1211 may terminate cutting because it is convex (as implied because it has no concave vertices). Subgraph 1212 may terminate cutting because it has reached a maximum tree depth.

Subgraph 2 788 may be cut into Subgraph 21 790, with #faces=2 and #concave verts=1 and Subgraph 22 792, with #faces=13 and #concave verts=2. Subgraph 21 790 may terminate cutting because there are only 2 faces. Subgraph 22 792 may be cut into Subgraph 221 794, with #faces=3 and #concave verts=2 and Subgraph 222 796, with #faces=10 and #concave verts=0. Subgraph 221 794 may terminate cutting because it may exceed a concave-to-face ratio (the ratio for this subgraph is 2/3, which may exceed a threshold) and Subgraph 222 796 may terminate cutting because it is convex (as implied because it has no concave vertices).

Hence, FIG. 7B shows a binary tree showing how Graph 0 772 is cut into subgraphs, until each leaf node has a termination condition (which may be a determination that the subgraph is convex, has only one face, has only two faces, a concavity-to-face ratio exceeds a threshold, or a maximum depth has been reached. At some point, any cutting stops because a maximum depth is reached, regardless of whether the other stopping conditions occur.

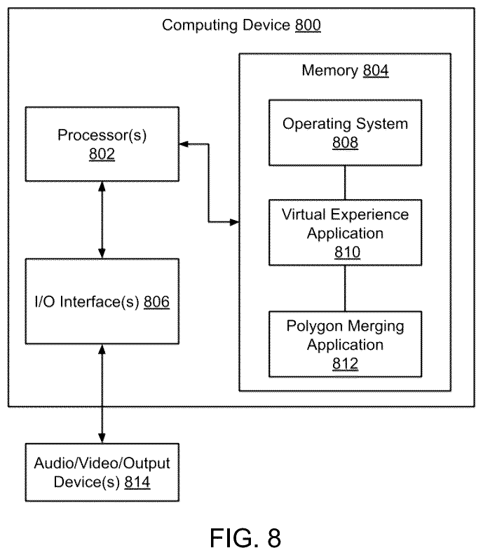

### FIG. 8—Example Computing Device

FIG. 8 is a block diagram that illustrates an example computing device 800, in accordance with some implementations.

FIG. 8 is a block diagram of an example computing device 800 which may be used to implement one or more features described herein. In one example, computing device 800 may be used to implement a computer device (e.g. 102 and/or 110 of FIG. 1), and perform appropriate method implementations described herein. Computing device 800 can be any suitable computer system, server, or other electronic or hardware device. For example, the computing device 800 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, device 600 includes a processor 802, a memory 804, input/output (I/O) interface 806, and audio/video input/output devices 814.

Processor 802 can be one or more processors and/or processing circuits to execute program code and control basic operations of the computing device 800. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 804 is typically provided in computing device 800 for access by the processor 802, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 802 and/or integrated therewith. Memory 804 can store software operating on the computing device 800 by the processor 802, including an operating system 808, one or more applications 810, e.g., a polygon merging application 812. In some implementations, application 810 can include instructions that enable processor 802 to perform the functions (or control the functions of) described herein, e.g., some or all of the methods described with respect to FIGS. 2A-2B and 7.

For example, applications 810 can include a polygon merging application 812, which as described herein can merge polygons within an online virtual experience server (e.g., 102). Elements of software in memory 804 can alternatively be stored on any other suitable storage location or computer-readable medium. In addition, memory 804 (and/or other connected storage device(s)) can store instructions and data used in the features described herein. Memory 804 and any other type of storage (magnetic disk, optical disk, magnetic tape, or other tangible media) can be considered “storage” or “storage devices.”

I/O interface 806 can provide functions to enable interfacing the computing device 800 with other systems and devices. For example, network communication devices, storage devices (e.g., memory and/or data store 120), and input/output devices can communicate via interface 806. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 814 can include a user input device (e.g., a mouse, etc.) that can be used to receive user input, a display device (e.g., screen, monitor, etc.) and/or a combined input and display device, that can be used to provide graphical and/or visual output.

For ease of illustration, FIG. 8 shows one block for each of processor 802, memory 804, I/O interface 806, and software blocks of operating system 808 and virtual experience application 810. These blocks may represent one or more processors or processing circuitries, operating systems, memories, I/O interfaces, applications, and/or software engines. In other implementations, computing device 800 may not have all of the components shown and/or may have other elements including other types of elements instead of, or in addition to, those shown herein. While the online virtual experience server 102 is described as performing operations as described in some implementations herein, any suitable component or combination of components of online virtual experience server 102 or similar system, or any suitable processor or processors associated with such a system, may perform the operations described.

A user device can also implement and/or be used with features described herein. Example user devices can be computer devices including some similar components as the computing device 800, e.g., processor(s) 802, memory 804, and I/O interface 806. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 814, for example, can be connected to (or included in) the computing device 800 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., method 200a, 200b, and/or 700) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

We claim:

1. A computer-implemented method to cut between coplanar convex polygons, the method comprising:
obtaining a plurality of coplanar convex polygons, each polygon having a plurality of vertices connected by a plurality of edges;
constructing an initial coplanar graph that represents the plurality of coplanar convex polygons, wherein vertices and edges of the initial coplanar graph correspond to respective vertices and edges of the plurality of coplanar convex polygons;
adding the initial coplanar graph into a queue;
cutting each graph in the queue, wherein the cutting of a graph comprises:
identifying whether the graph includes at least one concave boundary vertex;
if the graph includes no concave boundary vertex, adding the graph to a set of result graphs; and
if the graph includes at least one concave boundary vertex:
selecting the at least one concave boundary vertex of the graph as a starting vertex;
finding an optimal cut from the starting vertex to another boundary vertex of the graph;
splitting the graph along the optimal cut into two subgraphs; and
adding the two subgraphs to the queue for cutting;
repeating the cutting until one or more termination criteria is satisfied; and
outputting the set of result graphs.

2. The computer-implemented method of claim 1, further comprising using the set of result graphs to render the plurality of coplanar convex polygons.

3. The computer-implemented method of claim 1, wherein identifying whether the graph includes at least one concave boundary vertex comprises:
calculating graph boundary vertex angle for a vertex of the graph based on lengths of respective edges of coplanar convex polygons that connect the vertex of the graph to other vertices of the graph; and
determining that the vertex is the concave boundary vertex when the graph boundary vertex angle is >π radians.

4. The computer-implemented method of claim 3, wherein calculating the graph boundary vertex angle is based on an orientation predicate determinant, calculated with respect to exact arithmetic.

5. The computer-implemented method of claim 1, wherein the finding the optimal cut comprises:
identifying a plurality of sequences of corners in the graph being cut, each having an associated cost, wherein a corner is a path of two consecutive half-edges connecting three vertices; and
selecting a particular sequence of the plurality of sequences that is associated with a cost that is lower than the respective cost for other sequences of the plurality of sequences.

6. The computer-implemented method of claim 5, wherein identifying the plurality of sequences of corners in the graph comprises:
adding successive corners starting from a corner centered at the starting vertex to candidate sequences of corners until the particular sequence of corners that is associated with a cost that is lower than the respective cost for other sequences for the graph being cut is confirmed as the optimal cut for the graph being cut,
wherein a successive corner is added to the candidate sequences of corners if the successive corner provides a path to reach a vertex in the graph for which no other candidate sequence of corners provides a path with a lower cost.

7. The computer-implemented method of claim 5, wherein finding the optimal cut penalizes an additional corner that introduces a concave boundary vertex by increasing a cost of a sequence of corners that includes the additional corner.

8. The computer-implemented method of claim 5, wherein finding the optimal cut rewards an additional corner that resolves a concave boundary vertex by decreasing a cost of a sequence of corners that includes the additional corner.

9. The computer-implemented method of claim 1, further comprising:
generating circular tables of angles corresponding to vertices of each coplanar convex polygon when constructing the initial coplanar graph,
wherein identifying the concave boundary vertex is based on looking up a respective angle associated with the vertex in the circular tables of angles.

10. The computer-implemented method of claim 1, wherein if a corner comprises two collinear half-edges, the corner is associated with an angle measuring π radians, and otherwise the corner is associated with angles using an orientation predicate test with respect to exact arithmetic.

11. The computer-implemented method of claim 1, wherein determining that one or more of the termination criteria are satisfied comprises one or more of:
determining that the queue is empty;
determining that an amount of progress between consecutive executions of the cutting result in a less than threshold amount of progress; or
determining that an early termination threshold is met.

12. A non-transitory computer-readable medium comprising instructions that, responsive to execution by a processing device, causes the processing device to perform operations comprising:
obtaining a plurality of coplanar convex polygons, each polygon having a plurality of vertices connected by a plurality of edges;
constructing an initial coplanar graph that represents the plurality of coplanar convex polygons, wherein vertices and edges of the initial coplanar graph correspond to respective vertices and edges of the plurality of coplanar convex polygons;
adding the initial coplanar graph into a queue;
cutting each graph in the queue, wherein the cutting of a graph comprises:
identifying whether the graph includes at least one concave boundary vertex;
if the graph includes no concave boundary vertex, adding the graph to a set of result graphs; and
if the graph includes at least one concave boundary vertex:
selecting the at least one concave boundary vertex of the graph as a starting vertex;
finding an optimal cut from the starting vertex to another boundary vertex of the graph;
splitting the graph along the optimal cut into two subgraphs; and
adding the two subgraphs to the queue for cutting;
repeating the cutting until one or more termination criteria is satisfied; and
outputting the set of result graphs.

13. The non-transitory computer-readable medium of claim 12, wherein the instructions cause the processing device to perform further operations comprising using the set of result graphs to render the plurality of coplanar convex polygons.

14. The non-transitory computer-readable medium of claim 12, wherein identifying whether the graph includes at least one concave boundary vertex comprises:
calculating graph boundary vertex angle for a vertex of the graph based on lengths of respective edges of coplanar convex polygons that connect the vertex of the graph to other vertices of the graph; and
determining that the vertex is the concave boundary vertex when the graph boundary vertex angle is >π radians.

15. The non-transitory computer-readable medium of claim 12, wherein the finding the optimal cut comprises:
identifying a plurality of sequences of corners in the graph being cut, each having an associated cost, wherein a corner is a path of two non-boundary half-edges connecting three vertices; and
selecting a particular sequence of the plurality of sequences that is associated with a cost that is lower than the respective cost for other sequences of the plurality of sequences.

16. The non-transitory computer-readable medium of claim 12, wherein determining that one or more of the termination criteria are satisfied comprises one or more of:
determining that the queue is empty;
determining that an amount of progress between consecutive executions of the cutting result in a less than threshold amount of progress; or
determining that an early termination threshold is met.

17. A system comprising:
a memory with instructions stored thereon; and
a processing device, coupled to the memory, the processing device configured to access the memory and execute the instructions, wherein the instructions cause the processing device to perform operations including:
obtaining a plurality of coplanar convex polygons, each polygon having a plurality of vertices connected by a plurality of edges;
constructing an initial coplanar graph that represents the plurality of coplanar convex polygons, wherein vertices and edges of the initial coplanar graph correspond to respective vertices and edges of the plurality of coplanar convex polygons;
adding the initial coplanar graph into a queue;
cutting each graph in the queue, wherein the cutting of a graph comprises:
identifying whether the graph includes at least one concave boundary vertex;
if the graph includes no concave boundary vertex, adding the graph to a set of result graphs; and
if the graph includes at least one concave boundary vertex:
selecting the at least one concave boundary vertex of the graph as a starting vertex;
finding an optimal cut from the starting vertex to another boundary vertex of the graph;
splitting the graph along the optimal cut into two subgraphs; and
adding the two subgraphs to the queue for cutting;
repeating the cutting until one or more termination criteria is satisfied; and
outputting the set of result graphs.

18. The system of claim 17, wherein identifying whether the graph includes at least one concave boundary vertex comprises:
calculating graph boundary vertex angle for a vertex of the graph based on lengths of respective edges of coplanar convex polygons that connect the vertex of the graph to other vertices of the graph; and
determining that the vertex is the concave boundary vertex when the graph boundary vertex angle is >π radians.

19. The system of claim 17, wherein the finding the optimal cut comprises:
identifying a plurality of sequences of corners in the graph being cut, each having an associated cost, wherein a corner is a path of two non-boundary half-edges connecting three vertices; and
selecting a particular sequence of the plurality of sequences that is associated with a cost that is lower than the respective cost for other sequences of the plurality of sequences.

20. The system of claim 17, wherein determining that one or more of the termination criteria are satisfied comprises one or more of:
determining that the queue is empty;
determining that an amount of progress between consecutive executions of the cutting result in a less than threshold amount of progress; or
determining that an early termination threshold is met.
